(19) United States
(12) Patent Application Publication
(10) Pub. No.: US 2005/0049981 A1
(43) Pub. Date: Mar. 3, 2005

(54) System and method for transactions using purchaser identification

(76) Inventor: Stephen Randall Mixon, Painted Post, NY (US)

Correspondence Address: FISH & RICHARDSON P.C., 5000 BANK ONE CENTER, 1717 MAIN STREET, DALLAS, TX, 75201, US

(21) Appl. No.: 10/653,445

(22) Filed: Sep. 2, 2003

(51) Int. Cl. G06F 17/60

(52) U.S. Cl. 705/400

(57) ABSTRACT

A system and method of dispensing fuel from a fuel dispenser prior to receipt of payment includes receiving identifying information about a purchaser, dispensing the fuel, requesting payment for the value of the fuel dispensed, determining if sufficient payment is received and if sufficient payment is received, discarding the identifying information.

### TECHNICAL FIELD

This invention relates to automated sales transactions for goods and/or services, and more particularly to such transactions where it is desirable to know the identity of the purchaser of the goods and/or services.

### BACKGROUND

In many types of sales transactions, it is customary for the purchaser to pay for goods or services after receiving them. The convention has developed for both convenience and practical reasons. For example, in the context of the sale of fuel, a purchaser wishing to fill the fuel tank of his vehicle will usually not know the amount of fuel required until after the fuel is dispensed. Because it is more convenient and more practical for the purchaser to pay for the fuel after it is dispensed, rather than try to guess how much fuel the purchaser will need and pre-pay the amount, paying for fuel after dispensing has thus become the custom.

As transactions at the fuel dispensers have become more automated, however, there is less involvement by the fuel station attendant with the purchaser. This reduced personal involvement with the purchaser combined with larger fueling stations that are more difficult for the station attendant to monitor and other societal factors, have contributed to an increasing occurrence of fraud. For example, some persons may take advantage of the custom of paying after dispensing fuel by fueling their vehicle and then driving away without paying. Additionally, the lack of station attendant involvement facilitates unauthorized use of credit and debit accounts at an automated fuel dispenser.

Also, as transactions become more automated, the breadth of goods and services offered by automated vending machines, such as a fuel dispenser, also increases. Thus, it may be desirable that the increasing breadth include goods and services for which the purchaser must, because required by law or otherwise, meet a condition to sale. For example, most governmental entities regulate the sale of tobacco products (ex. cigarettes), alcoholic beverages, or gaming (ex. gambling or lottery and scratch off games for money) to minors. These types of items cannot usually be sold in an automated vending machine without being closely monitored by an attendant or in an appropriate context, such as an automated cigarette vending machine in a bar. In the context of an automated fuel dispenser, it may be desired to sell items such as gaming tickets and tobacco products together with the fuel, but without close monitoring by an attendant.

Therefore, there is a need for a system of conducting transactions in a customary manner, such as payment after receipt of the goods and/or services, but also in a manner that protects against or discourages fraud. Further, there is a need to enable automated transactions involving goods and/or services for which the purchaser must meet a condition to sale.

### SUMMARY

The exemplary embodiments described herein include a system and method for dispensing goods and/or services that utilize the purchaser's identification to protect against and discourage fraud in automated transactions. Further, the exemplary embodiments also enable automated transactions involving goods and/or services for which the purchaser must meet a condition for sale.

An exemplary method of dispensing fuel from a fuel dispenser prior to receipt of payment includes receiving identifying information about a purchaser of the fuel, dispensing the fuel, requesting payment for the value of the fuel dispensed, determining if sufficient payment is received, and if sufficient payment is received, discarding the identifying information.

An exemplary fuel dispenser includes a user input device operable to receive identifying information about a user of the fuel dispenser, a fuel dispensing assembly operable to dispense fuel and a controller operably coupled to the user input device and the fuel dispensing assembly. The controller is configured to perform the following functions: receive identifying information about the user of the fuel dispenser, enable the fuel dispensing assembly to dispense fuel, determine whether payment for the fuel is sufficient, and if payment is sufficient, discard the identifying information about the user of the fuel dispenser.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a flow diagram of an exemplary transaction in accordance with the invention;

FIG. 2 is a fuel dispenser in accordance with the invention;

FIG. 3 is a schematic of a controller and its connections in accordance with the invention;

FIG. 4 is an exemplary identification card in accordance with the invention;

FIG. 5 is a flow diagram of another exemplary transaction in accordance with the invention; and

FIG. 6 is a flow diagram of additional optional steps for inclusion in the exemplary transaction of FIG. 5.

Like reference symbols in the various drawings indicate like elements.

### DETAILED DESCRIPTION

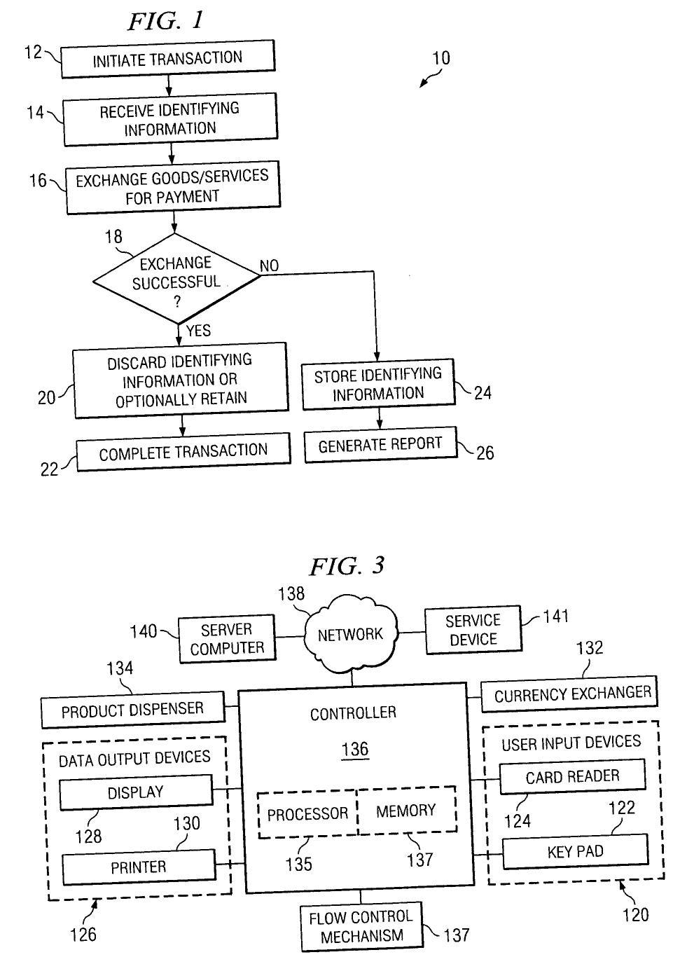

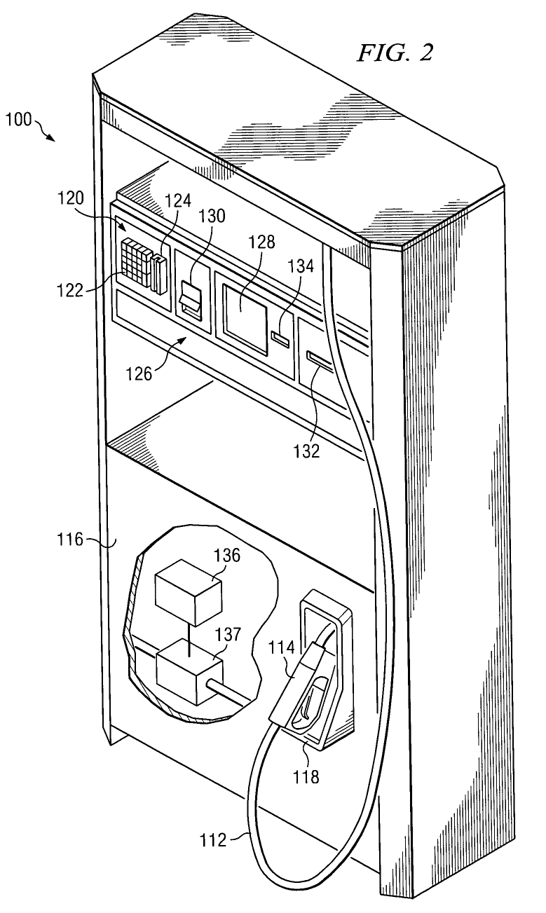

FIG. 1 depicts a flow diagram of an exemplary transaction 10 in accordance with the invention and for which identification of the purchaser is desired. The transaction 10 is intended to be automated, for example, taking place at a purchaser interface of an automated vending machine for dispensing goods, services, or vouchers for goods or services (herein collectively referred to as “goods and/or services”). In a second exemplary embodiment described below (FIGS. 2-6), the automated vending machine is a fuel dispenser at a service station that can be capable of dispensing fuel and other goods and/or services; however, the automated vending machine is not limited to a fuel dispenser and can include many other devices. Some other exemplary automated vending machines include a food or beverage vending machine, a vending machine that distributes controlled substances such as tobacco or alcohol, an automated ticket vending machine, a lottery or gaming machine, or other type of automated vending machine. One skilled in the art will appreciate the applicability of the concepts described herein to other types of automated vending machines, and such other types of automated vending machines are within the scope of this invention.

At step 12, the transaction is initiated when a purchaser is detected. The purchaser can be detected, for example, by sensing purchaser activity at the purchaser interface. Thereafter, at step 14, identifying information about the purchaser is received and stored. The purchaser may be prompted for the identifying information or the purchaser may input the identifying information on his own accord. The receipt of identifying information can also act as the action that prompts initiating the transaction at step 12.

At step 16, the exchange of goods and/or services for payment is performed. Depending on the particular application of the transaction 10, the goods and/or services may be dispensed prior to receipt of payment, after receipt of payment, or a deposit or pre-authorization for payment may be received prior to dispensing the goods and/or services and the payment for the goods and/or services received after dispensing the goods and/or services. Furthermore, at step 16, before dispensing the goods and/or services, it can optionally be determined using the identifying information whether the purchaser is authorized to purchase some or all of the goods and/or services. For example, if the identifying information includes the purchaser's age, the purchaser may be prevented from purchasing goods and/or services that are age restricted if the purchaser does not meet set age requirements.

At step 18 the exchange of goods and/or services for payment is reviewed to determine if it was successful. If successful, the identifying information can be discarded, substantially immediately after dispensing the goods and/or services if desired, at step 20, unless it is otherwise desired to maintain the identifying information. Thereafter, the transaction is completed at step 22. If unsuccessful, for example, payment for the goods and/or services is not received or is insufficient or the goods and/or services were not dispensed, the identifying information can be retained for further use at step 24 and optionally create a report including the identifying information at step 26. In an example where payment was not received or insufficient, but the goods and/or services were dispensed, the report generated at step 26 can be used to contact the purchaser to complete payment for the exchange or turned over to policing authorities for prosecution.

Referring now to FIGS. 2-6, a second exemplary embodiment of the invention as applied to the sale of fuel and other good and services at a fuel dispenser 100 will now be described. FIG. 2 depicts an exemplary fuel dispenser unit 100 that dispenses fuel through a hose 112 and nozzle 114. The hose 112 extends from a housing 116 of the fuel dispenser 100 and is in fluid communication with one or more fuel sources (not specifically shown). When not in use, the nozzle 114 resides in a receptacle 118 on a first side of the fuel dispenser housing 116. Though not specifically shown in FIG. 2, the fuel dispenser 100 may have additional hose 112 and nozzle 114 assemblies on a second side of the housing 116.

The fuel dispenser 100 is provided with one or more user input devices 120. The user input devices 120 are shown in FIG. 2 as a keypad 122 and card reader 124, but may include other types of devices that enable input of data from the purchaser. The card reader 124 is adapted to read a payment card, such as a credit or debit card, and an identification card, such as a government issued identification card or a privately issued identification card issued by a non-governmental entity.

The fuel dispenser 100 may also be provided with one or more data output devices 126. The data output devices 126 are shown in FIG. 2 as a display 128 and printer 130 for printing transaction receipts and other materials, such as lottery tickets, but may include other types of devices that enable output of data to the purchaser. The fuel dispenser 100 includes one or more components, such as pumps and/or valves (not specifically shown), adapted to enable, disable, and control the flow of fuel from one or more fuel sources to the nozzle 114. These one or more components are collectively referred to herein as the flow control mechanism 137. The fuel dispenser 100 may optionally be provided with a currency exchanger 132 for payment by currency at the dispenser 100 and a product dispenser 134 for dispensing goods, including vouchers for good or services, sold at the fuel dispenser 100. Some examples of goods that can be dispensed by the product dispenser 134 include food, beverages, gaming tickets (ex. lottery), and tobacco products.

With specific reference to FIG. 3, a controller 136 is provided. The controller 136 includes a programmable general-purpose processor 135 and memory or other machine readable medium 137. The controller 136 is operably coupled to the user input devices 120 (keypad 122 and card reader 124) and the output devices 126 (display 128 and printer 130) to receive data from the input devices 120 and communicate data to the output devices 126. The controller 136 is also operably coupled to the currency exchanger 132 to receive and output currency, to the product dispenser 134 to control dispensing of products sold at the dispenser 100, and to the flow control mechanism 137 to control the flow of fuel to nozzle 114 (FIG. 1). The controller 136 may be in communication with a network 138 that enables communications to and from the controller 136 with a server computer 140. The controller 136 may also communicate with additional devices on the network 138 including a service device 141, such as an automated car wash. The controller 136 may reside within the housing 116 of the fuel dispenser unit 100 (FIG. 1) or outside of the fuel dispenser 100 at a remote location.

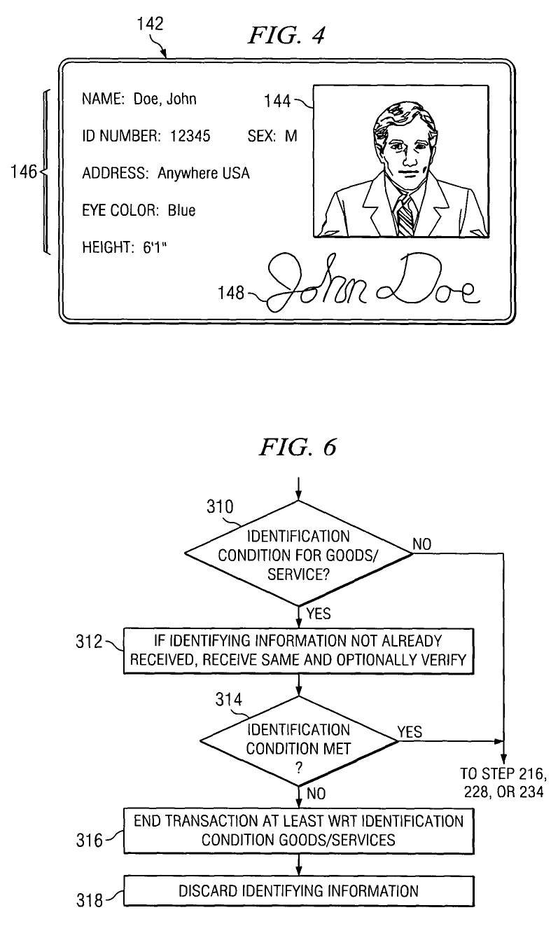

The fuel dispenser 100 is adapted to receive identifying information about the purchaser through the user input devices 120. The identifying information can be collected in various manners. In one exemplary embodiment, the fuel dispenser 100 is adapted to receive identifying information from a governmentally issued identification. Some examples of governmentally issued identification can include a driver's license, an identification card, a military identification card, a social security card, a passport, or other government issued identification. The fuel dispenser 100 can alternately, or in combination with governmental issued identification, receive identifying information from a privately issued identification, such as a membership card issued by the fuel station or from a credit or debit card. FIG. 4 depicts an identification card 142, either governmentally issued or privately issued. The identifying information can include, for example, the name, address, identification number and physical characteristics such as height, sex and eye color, a photo 144, and other information. While in most cases the identifying information is displayed as at least text in a text region 146, the identification card 142 often also includes identifying information in an encoded format, such as a barcode, magnetic stripe or a smart card type microprocessor, in an encoded region 148. One of ordinary skill in the art will appreciate that the identification need not take the form of a card, but can be any item that carries identifying information corresponding to the person to which it is issued.

In an embodiment where the identifying information takes the form of a card 142, the card reader 124 can be used to collect one or more pieces of information from the identification card 142. To this end, the card reader 124 can be adapted to read the information from the identification card 142 from the text region 146 or the encoded region 148 or both. For example, if the identification card 142 includes information as text in the text region 146 and magnetically encoded on a magnetic stripe in the encoded region 148, the card reader 124 can be adapted to read text on the face of the identification card 142 by optical character recognition routines. The card reader 124 may also or alternately be adapted to read the magnetic stripe in the encoded region 148. The card reader 20 is adapted to read the identifying information off of the identification card 142 in as many formats as are likely to be encountered by the specific fuel dispensing unit. Therefore, for example, if the fuel dispenser unit 10 resides in a governmental jurisdiction that issues governmental identification cards 142 having a bar code in the encoded region 148, the card reader 124 will be adapted to read at least bar codes. However, as the fuel dispenser unit 100 is likely to be used by travelers, the card reader 124 can be adapted to read other types of encoded information. Alternatively, or in combination with reading the text region 146 or the encoded region 148, the card reader 124 may be adapted to scan the identification card 142 to obtain a digital image of at least one side of the identification card 142 to allow it to be viewed, for example, by face recognition software or by a person.

The identifying information need not be contained on an identification card or item. For example, the identifying information can be a substantially unique biometric identifier or other identifier. In one exemplary embodiment, the controller 136 can be operably coupled to a camera to photograph the purchaser and/or the purchaser's vehicle. If desired, the photograph can be processed with facial recognition routines to identify the purchaser or optical character recognition routines to read the license plate of the purchaser's vehicle. In another exemplary embodiment, the controller 136 can be operably coupled to a microphone for use with voice recognition routines to identify the purchaser. In yet another exemplary embodiment, the controller 136 can be operably coupled to a retinal scanner, fingerprint scanner, other biometric input device to read such biometric input and thereby identify the purchaser. In another example, the purchaser can identify himself by inputting a pin at the keypad 122.

The identifying information need not come from a single source, but may come from two or more sources. In one exemplary embodiment, the identifying information can come from a governmentally issued identification and a substantially unique biometric identifier. In another exemplary embodiment, the identifying information can come from a governmentally issued identification and a privately issued identification.

Only one piece of identifying information need be received by the fuel dispenser 100. If additional information about the purchaser is required or desired, such information can be retrieved from a database stored at the controller 136, or remotely, such as at the server computer 140 accessible through the network. For example, the user input devices 120 can collect the governmental identification number from a governmentally issued identification, and additional identifying information, such as a name and physical characteristics of the purchaser, can be obtained at the time of the transaction or at some later time by reference to a database correlating identification numbers to the additional identifying information.

The identifying information may be verified at the time of the transaction or at some later time by comparison to a database stored at the controller 136, or remotely, such as at the server computer 140 accessible through the network 138. In one example, the user input devices 120 can collect multiple pieces of identifying information and verify that the multiple pieces of information are associated with the same individual, such as verify that the purchaser's name and address received by the input devices 120 correspond to a name and address in the database. In another example, the identifying information can be verified against a database of known customers to determine whether the purchaser meets criteria that would affect the purchase transaction, such as if the purchaser is known to have failed to complete payment for a prior transaction the purchaser may be requested to transact with the station attendant. Alternately, the identifying information can remain unverified, until it is later desired that the information be verified.

Referring now to FIGS. 2, 3, and 5, the controller 136 contains instructions stored on the machine readable medium 137. The instructions are operable on by the processor 135 to cause the controller 136, and thus the fuel dispenser 100, to execute an exemplary transaction 200. The exemplary transaction 200 is initiated at step 210. The transaction can be initiated by detecting a purchaser's presence at the fuel dispenser unit 100. The purchaser's presence can be detected, for example, by sensing activity at the user input device 120 such as detecting that a button has been pressed on the keypad 122 or detecting a card inserted in the card reader 124, sensing that the nozzle 114 has been removed from the receptacle 118, sensing contact or proximity to the housing 116, receipt of a signal to initiate the transaction such as from a fuel station attendant, or by other methods.

After the transaction is underway, the fuel dispenser unit 100 will prompt the purchaser for information on the method of payment at step 212. If the purchaser chooses to pre-pay for his purchase of goods and/or services the controller 136 will receive the pre-payment at step 214. The pre-payment can be received at the fuel dispenser 100 through the currency exchanger 132, or can be received at a remote location, for example by the fuel station attendant, and the pre-pay amount communicated to the controller 136. After pre-payment has been received, the controller 136 enables dispensing of the goods and/or services up to the amount of the pre-payment at step 214. For example, if the purchaser pre-pays for $10 in cash for fuel, the controller 136 operates the flow control mechanism 137 to dispense up to $10 worth of fuel. If necessary, change for goods and/or services dispensed less than the pre-paid amount can be returned either by the currency exchanger 132 or remotely, for example by the fuel station attendant. In another example, if the purchaser pre-pays $10 for fuel by credit or debit with the station attendant, after the transaction has been posted to the purchasers account or otherwise verified, the controller 136 will enable dispensing of $10 worth of fuel. After the goods and/or services have been dispensed, and any change returned, the transaction is complete at step 300.

If the purchaser chooses to pay by debit or credit at the fuel dispenser 100, it may be desirable to collect identification information about the purchaser. If it is desired to collect identification information about the purchaser, the controller 136 receives the identifying information through the user input devices 120 at step 218. The controller 136 may prompt the user for the identifying information, for example through one or more of the data output devices 126 such as the display 128, or the user may input the identifying information on his own accord without prompting. The receipt of identifying information can also act as the action that prompts initiating the transaction at step 210. In an example where the identifying information is in the form of an identification card, the purchaser swipes the card through the card reader 124 to input the identifying information. Thereafter, the identifying information can be optionally verified as discussed above. If it is not desired to collect identification information, step 218 is not performed, and if desired, can be omitted from the controller's 136 logical code all together.

The debit or credit account information is received through the user input devices 120 at step 220. As above, the controller 136 may prompt the user for the debit or credit account information through one or more of the data output devices 126 or the user may input the account information on his own accord without prompting. In an example where the account information is in the form of a credit or debit card, the purchaser swipes the card through the card reader 124 to input the account information. Thereafter, if desired, the identifying information can be compared to the account information to determine whether the purchaser is authorized to use the credit or debit account at step 222. If not authorized, the purchaser can be prevented from using the credit or debit account and the transaction ended at 224. The identifying information can be optionally retained at step 226 if desired, for example, to report attempted unauthorized use of the credit or debit account.

If the purchaser is authorized to use the credit or debit account or no check for purchaser authorization is performed, the controller 136 then enables dispensing of goods and/or services and payment for the goods and/or services is deducted from the debit or credit account at step 228. The identifying information is discarded, substantially immediately after dispensing the goods and/or services if desired, at step 230, but can be maintained if so desired. The transaction is completed at step 300.

If the purchaser chooses to make payment after dispensing goods and/or services, for example by paying cash at the dispenser 100 or by paying cash, credit or debit to the station attendant, the controller 136 receives the identifying information through the user input devices 120 in a manner described above at step 232. The controller 136 may prompt the purchaser for the identifying information, for example through one or more of the data output devices 126, or the user may input the identifying information on his own accord without prompting. Thereafter, the identifying information can be optionally verified as discussed above. After receipt of the identifying information and verification, if any, the controller 136 enables dispensing of goods and/or services at step 234. The value of the goods and/or services dispensed to the purchaser is output through one or more data output devices 126 at step 236.

The purchaser pays for the goods and/or services, and at step 238 it is determined whether the payment was received, and if payment was received, whether the payment is sufficient. If payment for the dispensed goods and/or services is not received or is insufficient, the identifying information is stored together with information relating to the transaction at step 226. A report can be generated from this information and the report can be used in contacting the purchaser to complete payment or turned over to policing authorities for prosecution. If payment for the dispensed goods and/or services is sufficient, the identifying information can be discarded, substantially immediately after dispensing the goods and/or services if desired, at step 240 and transaction completed at step 300. However, the identifying information can be optionally retained, if so desired.

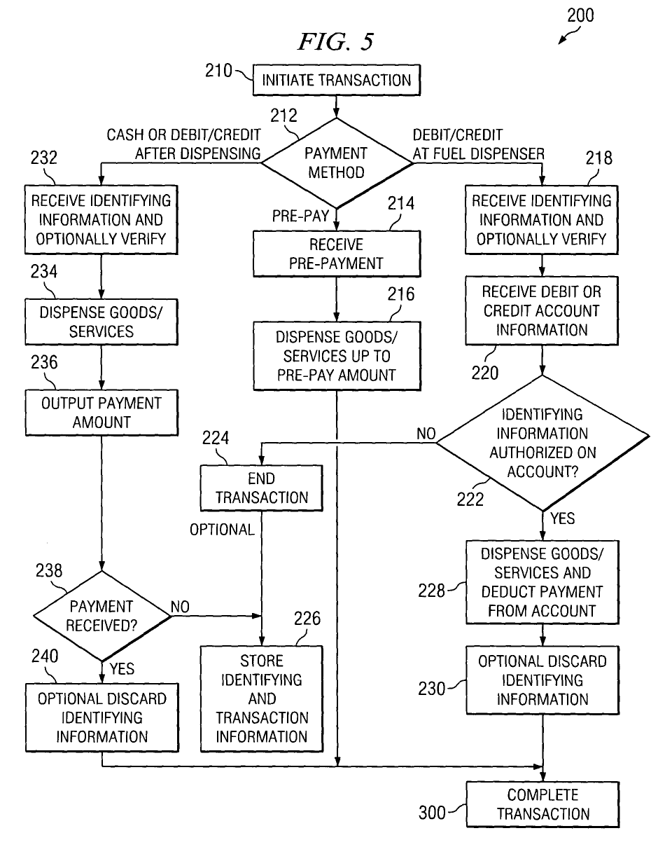

In some situations, the transaction may involve the sale of goods and/or services for which it is desirable or necessary to collect identification information on the purchaser for reasons other than the order and manner by which the exchange of payment for goods and/or services is being made. For example, some or all of the goods and/or services in a transaction may be of a type that is governmentally controlled and salable only to a purchaser who meets certain requirements (i.e. satisfies a condition), such as a minimum age requirement for the sale of alcoholic beverages, tobacco, or gaming tickets or a licensure requirement to purchase certain products. If the dispenser 100 is operable to dispense goods and/or services for which it is otherwise desirable or necessary to collect identification information, the exemplary method depicted in FIG. 5 can include the additional steps depicted in FIG. 6 and discussed below incorporated preceding the dispensing steps 216, 228 and 234 or elsewhere as is desired.

Referring to FIG. 6, at step 310 it is determined whether identifying information about the purchaser is desirable or necessary for sale of the goods and/or services requested by the purchaser, for example, to check a condition for the sale. If not, the goods and services can be dispensed as normal. If identifying information is desirable or necessary for sale of the goods and/or services, and the purchaser's identifying information has not already been received, the identifying information is received at step 312. At step 314, the identifying information is evaluated to determine if the condition for sale is satisfied. If satisfied, the goods and/or services are dispensed as in FIG. 6. If the condition for sale is not satisfied, the transaction is ended at step 316 for at least the goods and/or services for which the condition for sale was not met. Any goods and/or services for which there is no condition for sale or the condition for sale is met, the goods and/or services can be dispensed as in FIG. 6. At step 318, the identifying information is discarded, but can be retained if needed for the transaction or if it is otherwise desired to retain the information.

An advantage of the invention is that it provides a manner in which to conduct cash based sales transactions at a fuel dispenser in a customary manner by enabling the purchaser to dispense goods and/or services, including fuel, and tender payment after receipt of the goods and/or services. A further advantage of the invention is that it provides a manner in which to reduce the liability of the service station on transactions where payment authorization is performed by the station rather than a third party credit or debit card company. Thus, receiving the identifying information prior to dispensing the goods and/or services provides the fuel station recourse if the purchaser fails to tender payment or tenders an incomplete payment. The identifying information can be collected from a governmental identification, such as a driver's license or ID card. Governmental identification provides a convenient manner from which to collect identifying information about a purchaser, because the government takes steps to ensure the information is accurate, the government bears the cost of collecting the information and issuing the identification, and virtually all purchasers at a fuel dispenser will have a governmental identification. One of ordinary skill in the art will appreciate additional advantages of the invention beyond those mentioned here.

A number of embodiments of the invention have been described. Nevertheless, it will be understood that various modifications may be made without departing from the spirit and scope of the invention. Accordingly, other embodiments are within the scope of the following claims.

1. A method of dispensing fuel from a fuel dispenser prior to receipt of payment, comprising:
receiving identifying information about a purchaser of the fuel;
dispensing the fuel;
requesting payment for the value of the fuel dispensed;
if payment tendered, receiving payment;
determining if sufficient payment is received; and
if sufficient payment is received, discarding the identifying information.

2. The method of claim 1 wherein if sufficient payment is not received, retaining the identifying information.

3. The method of claim 2 further comprising reporting the identifying information to the appropriate policing authority.

4. The method of claim 1 wherein receiving identifying information comprises receiving identifying information from a governmentally issued identification.

5. The method of claim 4 wherein the governmentally issued identification is a driver's license.

6. The method of claim 4 further comprising:
receiving a request from the purchaser for at least one good and/or service in addition to the fuel;
determining from the identifying information if the purchaser meets a condition to sale of the at least one good and/or service; and
if the purchaser does not meet the condition to sale, not dispensing the at least one good and/or service to which the condition applies.

7. The method of claim 6 wherein the at least one good and/or service comprises at least one of a gaming ticket, a tobacco product, and an alcoholic beverage.

8. The method of claim 6 wherein the identifying information includes the purchaser's age and wherein the condition to sale is age.

9. The method of claim 1 wherein receiving identifying information comprises receiving identifying information from a privately issued identification.

10. The method of claim 1 wherein receiving identifying information comprises receiving a substantially unique biometric identifier.

11. The method of claim 1 wherein receiving identifying information comprises receiving identifying information from two or more different sources.

12. The method of claim 1 further comprising verifying the identifying information against a database.

13. The method of claim 1 further comprising comparing the identifying information against a database to determine if the purchaser is an authorized user of an account presented for payment.

14. The method of claim 1 wherein dispensing at least one good or service comprises:
receiving a request for at least one good and/or service in addition to fuel;
determining from the identifying information if the purchaser meets a condition to sale of the at least one good and/or service; and
if the purchaser does not meet the condition to sale, not dispensing the at least one good and/or service to which the condition applies.

15. The method of claim 14 wherein the identifying information includes the purchaser's age and wherein the condition to sale is a minimum age.

16. An article comprising a machine readable medium storing instructions operable to cause one or more machines to perform operations comprising:
determining if identifying information about a purchaser is desired for a transaction;
if identifying information about a purchaser is desired, receiving identifying information about a purchaser of at least one good and/or service;
dispensing the at least one good and/or service;
if payment for the at least one good and/or service has not been received, requesting payment for the value of the at least one good and/or service dispensed; and
determining if sufficient payment is received and if sufficient payment is received and if identifying information about a purchaser is received, discarding the identifying information.

17. The article of claim 16 wherein the instructions are further operable to cause one or more machines to perform operations comprising:
determining that identifying information about a purchaser is desired if the purchaser wishes to pay for the at least one good and/or service dispensed after receipt of the at least one good and/or service dispensed.

18. The article of claim 16 wherein the instructions are further operable to cause one or more machines to perform operations comprising:
requesting pre-payment for the value of the at least one good and/or service the purchaser desires to be dispensed prior to dispensing the at least one good and/or service.

19. The article of claim 16 wherein the instructions are further operable to cause one or more machines to perform operations comprising:
determining that identifying information about the purchaser is desired if the purchaser requests at least one good and/or service having a condition of sale requiring identifying information about the purchaser to verify.

20. The article of claim 19 wherein the instructions are further operable to cause one or more machines to perform operations comprising:
determining from the identifying information if the purchaser meets the condition of sale; and
if the purchaser does not meet the condition of sale, not dispensing the at least one good and/or service to which the condition applies.

21. The article of claim 20 wherein the condition of sale is that the purchaser be of a minimum age.

22. The article of claim 20 wherein the goods and/or services comprise at least one of a gaming ticket, a tobacco product, and an alcoholic beverage.

23. A fuel dispenser, comprising:
a user input device operable to receive identifying information about a user of the fuel dispenser;
a fuel dispensing assembly operable to dispense fuel; and
a controller operably coupled to the user input device and the fuel dispensing assembly, the controller configured to perform the following:
receive identifying information about the user of the fuel dispenser; enable the fuel dispensing assembly to dispense fuel;
determine whether payment for the fuel is sufficient; and
if payment is sufficient, discard the identifying information about the user of the fuel dispenser.

24. The fuel dispenser of claim 23 wherein the controller is further configured to perform the following:
if sufficient payment is not received, retain the identifying information.

25. The fuel dispenser of claim 23 wherein the user input device is operable to receive identifying information from a governmentally issued identification.

26. The fuel dispenser of claim 25 wherein the governmentally issued identification is a driver's license.

27. The fuel dispenser of claim 23 wherein the controller is further configured to perform the following:
receive a request for at least one good and/or service other than fuel;
determine from the identifying information if the user meets a condition to sale of the at least one good and/or service; and
if the user does not meet the condition to sale, not dispense the at least one good and/or service to which the condition applies.

28. The fuel dispenser of claim 27 wherein the at least one good and/or service comprises at least one of a gaming ticket, a tobacco product, and an alcoholic beverage.

29. The fuel dispenser of claim 27 wherein the identifying information includes the user's age and the condition to sale is a minimum age.

30. The fuel dispenser of claim 23 wherein the user input device is operable to receive identifying information from a privately issued identification.

31. The fuel dispenser of claim 23 wherein the user input device is operable to receive identifying information as a substantially unique biometric identifier.

32. The fuel dispenser of claim 23 wherein the controller is further configured to perform the following:
verify the identifying information against a database.

33. The fuel dispenser of claim 23 wherein the controller is further configured to perform the following:
determine if the user is an authorized user of an account presented for payment.
